(19) United States
(12) Patent Application Publication
(10) Pub. No.: US 2025/0102358 A1
(43) Pub. Date: Mar. 27, 2025

(54) SPECTROSCOPIC ANALYZER

(71) Applicant: HAMAMATSU PHOTONICS K.K., Hamamatsu-shi (JP)

(72) Inventor: Tatsuo DOUGAKIUCHI, Hamamatsu-shi (JP)

(73) Assignee: HAMAMATSU PHOTONICS K.K., Hamamatsu-shi (JP)

(21) Appl. No.: 18/884,192

(22) Filed: Sep. 13, 2024

(30) Foreign Application Priority Data
Sep. 22, 2023 (JP) 2023-157454

(51) Int. Cl. G01J 3/18; G01J 3/02; G01J 3/04; G01J 3/10; G01J 3/26

(52) U.S. Cl. CPC G01J 3/1804; G01J 3/0208; G01J 3/021; G01J 3/0275; G01J 3/04; G01J 3/10; G01J 3/26

(57) ABSTRACT

A spectroscopic analyzer according to an embodiment includes: a Fabry-Perot QCL element configured to emit a laser light including a plurality of mode lights respectively corresponding to a plurality of modes indicating a discrete oscillation spectrum; a diffraction grating configured to disperse the laser light emitted from the QCL element into the plurality of mode lights; and a light detector configured to detect the mode light dispersed by the diffraction grating and then transmitted through a sample.

### TECHNICAL FIELD

The present disclosure relates to a spectroscopic analyzer.

### CROSS-REFERENCE TO RELATED APPLICATIONS

This application claims the benefit of priority from Japanese Patent Application No. 2023-157454 filed on Sep. 22, 2023, the entire contents of which are incorporated herein by reference.

### BACKGROUND

Since strong absorption derived from basic vibration of a molecule is observed in mid-infrared light (wavelength: 3 μm to 20 μm), mid-infrared light is mainly used for absorption spectroscopy (spectroscopic analysis method) having a gas molecule as a target. As a device configuration for performing such a spectroscopic analysis method, a dispersion method using a dispersion element such as a diffraction grating or a prism is known. As a conventional dispersion method, there is known a method in which radiation light from a broadband lamp light source is dispersed by a dispersion element, and detection is performed by a light detector for each dispersed wavelength component (for example, refer to Patent Literature 1 (Japanese Unexamined Patent Publication No. 2010-197310).

### SUMMARY

In the conventional dispersion method as described above, wavelength resolution depends on performance of a dispersion element such as the number of grooves of a grating. In addition, in the case of using a single light detector, a movable unit (for example, a mechanism for rotating the dispersion element) for changing an angle of the dispersion element is required, and high reproducibility of a repeated operation of the movable unit affects wavelength accuracy. On the other hand, in a case where a line sensor is used as the light detector, the movable unit as described above can be omitted, but it is necessary to use a narrow pitch line sensor in order to obtain high wavelength resolution. As described above, in the conventional dispersion method, since wavelength accuracy and wavelength resolution as a spectroscope are determined by several factors such as performance of the dispersion element, a pitch of the line sensor, and operation accuracy of the movable unit, an expensive elemental technology (for example, a narrow pitch line sensor, a piezo actuator for changing the angle of the dispersion element with high accuracy, or the like) is required for enhancing performance. Further, the lamp light source used in the conventional dispersion method has a wide emission wavelength range, but has small light intensity for each wavelength component. Therefore, measurement light obtained by dispersing radiation light from the lamp light source for each wavelength component with high wavelength resolution is extremely weak. In order to accurately measure such weak measurement light, a highly sensitive light detector is essential.

Therefore, an object of one aspect of the present disclosure is to provide a spectroscopic analyzer capable of realizing a configuration having high wavelength accuracy and wavelength resolution at low cost.

The present disclosure includes the following spectroscopic analyzer [1] to [16].

[1] A spectroscopic analyzer including:
a Fabry-Perot quantum cascade laser element configured to emit a laser light including a plurality of mode lights respectively corresponding to a plurality of modes indicating a discrete oscillation spectrum;
a spectroscopic unit configured to disperse the laser light emitted from the quantum cascade laser element into the plurality of mode lights; and
a light detector configured to detect the mode light dispersed by the spectroscopic unit and then transmitted through a sample or reflected by the sample.

The spectroscopic analyzer according to [1] includes the Fabry-Perot quantum cascade laser element that oscillates a plurality of discretely distributed mode lights as a light source for spectroscopic analysis of a dispersion method. As a result, wavelength resolution and wavelength accuracy can be defined by a mode interval. In addition, since a light output of the Fabry-Perot quantum cascade laser element is larger than that of a lamp light source used as a light source in the conventional dispersion method, a light intensity of each discretized mode light (each wavelength component) becomes relatively large, and thus, the light detector is not required to have high sensitivity. Therefore, with the spectroscopic analyzer, a configuration having high wavelength accuracy and wavelength resolution can be realized at low cost.

[2] The spectroscopic analyzer according to [1], further including a reflector including a first plane mirror and a second plane mirror disposed to face each other, the reflector guiding the mode light to the light detector while performing multiple reflection of the mode light between the first plane mirror and the second plane mirror, in which
the first plane mirror and the second plane mirror are inclined to each other such that a distance between the first plane mirror and the second plane mirror increases from a side on which the mode light is incident toward a side from which the mode light is emitted to the light detector, and
the light detector is configured to detect the mode light transmitted through the sample disposed between the first plane mirror and the second plane mirror.

According to the configuration of [2], the multiple reflection of the mode light is performed between the first plane mirror and the second plane mirror on which the sample is disposed, so that an optical path length of the mode light passing through a space between the first plane mirror and the second plane mirror can be increased while an increase in size of the analyzer is suppressed. Therefore, an interval between the modes adjacent to each other can be increased. This facilitates individual detection of each mode light by the light detector.

[3] The spectroscopic analyzer according to [2], in which
the reflector is disposed to allow the mode light to be first incident on the first plane mirror, and
the first plane mirror has an inclination angle relative to the second plane mirror, the inclination angle being configured to coincide with an incident angle obtained when the mode light detected by the light detector is first incident on the first plane mirror.

According to the configuration of [3], it is possible to facilitate an arrangement design of an optical path of the mode light that travels by multiple reflection between the first plane mirror and the second plane mirror and the light detector corresponding thereto.

[4] The spectroscopic analyzer according to any one of [1] to [3], in which the spectroscopic unit is a MEMS diffraction grating configured to be rotatable so as to change an incident angle of the laser light relative to the spectroscopic unit.

According to the configuration of [4], the size of the spectroscopic analyzer can be reduced, and high-speed angular sweep (that is, wavelength (mode) scanning of the mode light detected by the light detector) can be performed.

[5] The spectroscopic analyzer according to any one of [1] to [4], further including a slit member disposed between the sample and the light detector on an optical path of the mode light, the slit member having a slit provided therein and configured to selectively allow the mode light corresponding to one of the plurality of modes to pass therethrough.

According to the configuration of [5], when the slit member is provided at a preceding stage of the light detector, only light of one mode (wavelength component) can be selectively detected by the light detector.

[6] The spectroscopic analyzer according to [5], further including a collimating lens disposed between the quantum cascade laser element and the spectroscopic unit and configured to collimate the laser light, in which a position of a beam waist of the laser light collimated by the collimating lens is aligned with a position of the slit.

According to the configuration of [6], the mode lights adjacent to each other can be more clearly separated at the slit position, and the light of each mode can be easily detected independently.

[7] The spectroscopic analyzer according to [5] or [6], further including a cylindrical lens disposed between the sample and the slit member on the optical path of the mode light and configured to condense the mode light in a longitudinal direction of the slit.

According to the configuration of [7], by compressing the mode light incident on the slit in the longitudinal direction of the slit, the light amount of the mode light passing through the slit can be increased, and the light amount of the mode light finally incident on the light detector can be increased.

[8] The spectroscopic analyzer according to any one of [1] to [7], further including a collimating lens disposed between the quantum cascade laser element and the spectroscopic unit and configured to collimate the laser light,
in which a position of a beam waist of the laser light collimated by the collimating lens is aligned with a position of a light receiving surface of the light detector.

According to the configuration of [8], the mode lights adjacent to each other can be more clearly separated on the light receiving surface of the light detector, and the light of each mode can be easily detected independently.

[9] The spectroscopic analyzer according to any one of [1] to [8], in which the light detector is a quantum type detector.

According to the configuration of the above [9], the mode light can be detected with higher sensitivity and higher speed as compared with a case in which the thermal detector is used as a light detector.

[10] The spectroscopic analyzer according to any one of [1] to [9], further including a cylindrical lens disposed between the sample and the light detector on an optical path of the mode light and configured to condense the mode light in a direction orthogonal to both a direction in which the mode lights adjacent to each other are shifted from each other and a traveling direction of the mode light.

According to the configuration of [10], it is possible to increase the amount of light incident on the light detector by condensing the mode light in one direction while maintaining a state in which the mode lights adjacent to each other are separated from each other by the cylindrical lens.

[11] The spectroscopic analyzer according to any one of [1] to [10], further including a long focus lens disposed between the spectroscopic unit and the light detector, in which the long focus lens allows the plurality of mode lights dispersed by the spectroscopic unit to pass therethrough and has a focal length of 15 cm or more and 3 m or less.

According to the configuration of [11], each of the plurality of mode lights incident on the long focus lens can be condensed at different positions on the focal plane of the long focus lens according to the incident angle relative to the long focus lens. This facilitates individual detection of the plurality of mode lights by the light detector.

[12] The spectroscopic analyzer according to any one of [1] to [11], in which the quantum cascade laser element is configured to generate light by a transition between a plurality of subbands.

[13] The spectroscopic analyzer according to any one of [1] to [11], in which the quantum cascade laser element is configured to include a plurality of active layers having center wavelengths different from each other.

According to the configuration of [12] or [13], it is possible to realize a quantum cascade laser element that emits laser light including light of a plurality of modes discretely distributed in a wide band. As a result, an analyzable wavelength range can be set wide.

[14] The spectroscopic analyzer according to any one of [1] to [13], further including an analysis unit configured to analyze a measurement result of the light detector,
in which the analysis unit is configured to execute:
   first processing of acquiring time-series data of a signal value detected by the light detector by controlling an operation of the spectroscopic unit so that each of the plurality of mode lights is detected by the light detector in order of wavelength magnitude;
   second processing of determining a wavelength corresponding to at least one first peak among a plurality of peaks included in the time-series data acquired by the first processing; and
   third processing of determining a wavelength of a second peak other than the first peak among the plurality of peaks based on a positional relationship between the first peak and the second peak.

According to the configuration of [14], by extracting a peak derived from each mode included in the measurement result (time-series data) and determining a wavelength corresponding to each peak, it is possible to appropriately grasp a signal value for each wavelength while securing wavelength resolution and wavelength accuracy as a spectroscope by a mode interval (a peak interval).

[15] The spectroscopic analyzer according to [14], in which the analysis unit is configured to determine, in the second processing, the wavelength corresponding to the first peak by comparing information indicating an oscillation spectrum of the laser light acquired in advance with the time-series data.

According to the configuration of [15], the wavelength corresponding to the first peak serving as a reference when the third processing is executed can be appropriately determined based on the oscillation spectrum of the laser light acquired in advance.

[16] The spectroscopic analyzer according to [14], in which
the mode light dispersed by the spectroscopic unit is configured to pass through a specific substance that absorbs light of a specific wavelength before reaching the light detector, and
the analysis unit is configured to, in the second processing, specify a position of an absorption line appearing at a position corresponding to the specific wavelength in the time-series data and determine a wavelength corresponding to the first peak based on the position of the absorption line.

According to the configuration of [16], the wavelength corresponding to the first peak serving as a reference when the third processing is executed can be appropriately determined based on the position of the absorption line observed in the measurement result (time-series data).

According to one aspect of the present disclosure, it is possible to provide a spectroscopic analyzer capable of realizing a configuration having high wavelength accuracy and wavelength resolution at low cost.

### BRIEF DESCRIPTION OF THE DRAWINGS

FIG. 1 is a schematic configuration diagram of a spectroscopic analyzer according to a first embodiment;

FIG. 2 is a diagram illustrating an example of current-light output characteristics of a QCL element;

FIG. 3 is a diagram illustrating an example of an oscillation spectrum of the QCL element;

FIG. 4 is a diagram illustrating an example of an optical path of mode light between mirrors of a reflector;

FIG. 5 is a diagram illustrating an example of a measurement result for each rotation (each step) of a diffraction grating;

FIG. 6 is a diagram illustrating a state in which each number is allocated to each peak of the spectrum in FIG. 3;

FIG. 7 is a diagram illustrating a state in which each number is allocated to each peak of a differential value with respect to the measurement result in FIG. 5;

FIG. 8 is a schematic configuration diagram of a spectroscopic analyzer according to a second embodiment;

FIG. 9 is a schematic configuration diagram of a spectroscopic analyzer according to a third embodiment;

FIG. 10 is a diagram schematically illustrating a condensing point of each mode light on a focal plane of a long focus lens; and

FIG. 11 is a schematic configuration diagram of a spectroscopic analyzer according to a fourth embodiment.

### DETAILED DESCRIPTION

Hereinafter, an embodiment of the present disclosure will be described in detail with reference to the drawings. It is noted that, in the following description, identical or equivalent elements are denoted by identical reference numerals, and a redundant description thereof will be omitted.

### First Embodiment

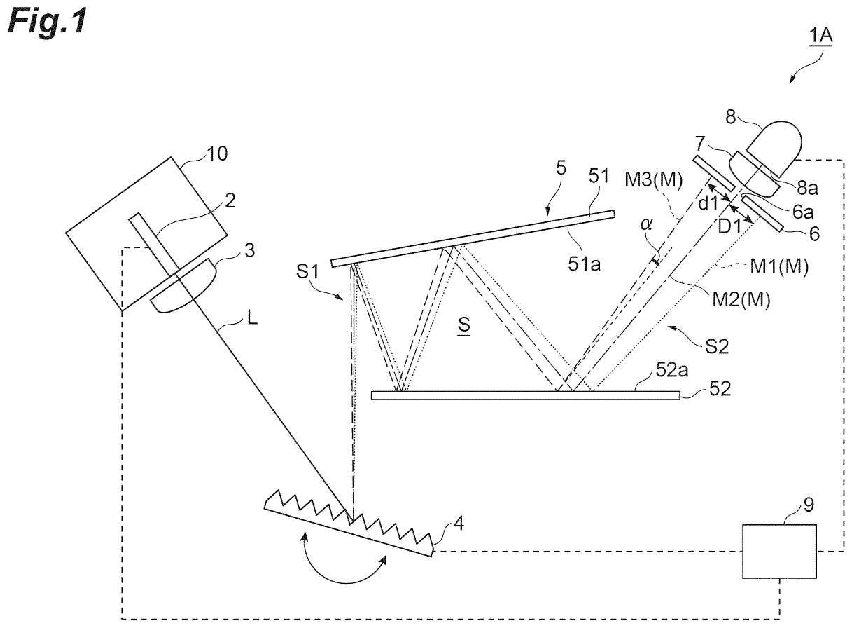

A spectroscopic analyzer 1A (spectroscopic module) according to a first embodiment will be described with reference to FIGS. 1 to 7. As illustrated in FIG. 1, the spectroscopic analyzer 1A includes a quantum cascade laser element (hereinafter, referred to as a “QCL element”) 2, a collimating lens 3, a diffraction grating 4 (a spectroscopic unit), a reflector 5, a slit member 6, a condensing lens 7, a light detector 8, and an analysis unit 9.

The QCL element 2 is a Fabry-Perot quantum cascade laser element (FP-QCL) that emits a laser light L including a plurality of mode lights M respectively corresponding to a plurality of Fabry-Perot modes (hereinafter, simply referred to as a “mode”) that exhibit a discrete oscillation spectrum. That is, the QCL element 2 has an oscillation spectrum including a spectrum sequence in which wavelengths are discretized at substantially constant intervals (mode intervals). As illustrated in FIG. 1, the QCL element 2 is mounted in a heat sink 10.

In the present embodiment, the QCL element 2 is configured as a relatively broadband laser element in order to widen a wavelength range measurable by the spectroscopic analyzer 1A. That is, the QCL element 2 is configured to be able to output a plurality of discrete mode lights M in a relatively wide wavelength range. As an example, the QCL element 2 may be configured to generate light by a transition between a plurality of subbands. For example, the QCL element 2 may be configured to have a dual-upper-state (DAU) subband level structure as disclosed in Japanese Patent No. 6276758. That is, the QCL element 2 may be configured such that light emission due to the transition between the plurality of subbands occurs between a plurality of light emission upper levels and one or more light emission lower levels. As another example, the QCL element 2 may include a plurality of active layers having center wavelengths different from each other. Any one of the above configurations can suitably widen the bandwidth of the QCL element 2. That is, according to any one of the above configurations, it is possible to realize the QCL element 2 that emits the laser light L including the light of the plurality of modes discretely distributed in the wide band. As a result, the measurable wavelength range can be set wide. In the present embodiment, as an example, the QCL element 2 is configured as an FP-QCL of a double upper level type having a center wavelength of 9 μm.

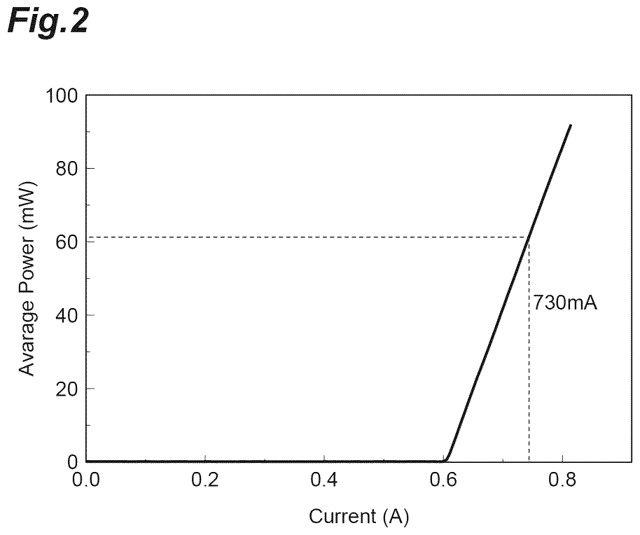

FIG. 2 illustrates an example of current-light output characteristics when the temperature of the heat sink 10 is controlled to be maintained at 20° C. and the QCL element 2 is continuously driven. In FIG. 2, the horizontal axis represents an injection current (mA) with respect to the QCL element 2, and the vertical axis represents an average output (mW) of the laser light L output from the QCL element 2. As illustrated in FIG. 2, in the present embodiment, the QCL element 2 is configured to obtain an average output of about 60 mW when the injection current is 730 mA.

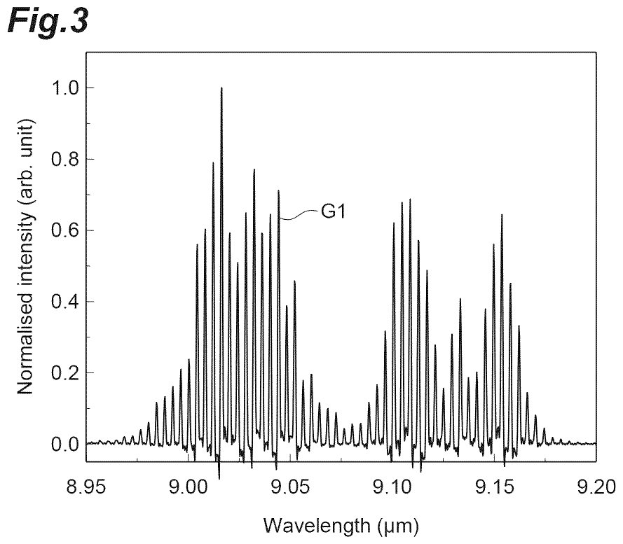

A graph G1 illustrated in FIG. 3 illustrates an oscillation spectrum of the QCL element 2 acquired by Fourier transform infrared spectroscopy (FTIR) when the injection current in FIG. 2 is 730 mA. In FIG. 3, the horizontal axis represents a wavelength (μm), and the vertical axis represents a spectral intensity normalized such that a maximum peak value becomes “1”. As described above, the oscillation spectrum of the QCL element 2, which is FP-QCL, is formed of a discretized spectrum sequence (a sequence of a plurality of peaks). Here, a mode interval (a wavelength difference between adjacent peaks) Δλ of the QCL element 2 is expressed by the following formula (1). In the following formula (1), “λ₀” is a center wavelength of the QCL element 2, “n_{eff}” is an effective refractive index of the QCL element 2, and “L” is a resonator length of the QCL element 2.

$$Δ λ = {λ}_{0}^{2} / 2 {n}_{eff} L \qquad ( 1 )$$

Here, since the effective refractive index n_{eff} of the QCL element 2 depends on the wavelength, the mode interval Δλ slightly changes from the short wavelength side to the long wavelength side of the oscillation spectrum. That is, the mode interval Δλ is not strictly constant in the wavelength range including the spectrum sequence illustrated in FIG. 3. In the example of FIG. 3, the mode interval Δλ on the short wavelength side (around 8.97 μm) is calculated to be 4.39 nm and the mode interval Δλ on the long wavelength side (around 9.17 μm) is calculated to be 4.45 nm by the above Formula (1). However, in the present embodiment, an error (a deviation width) from the average value of the mode interval on the short wavelength side and the mode interval on the long wavelength side is 1% or less with respect to the average value 4.42 nm of the mode intervals on the short wavelength side and the long wavelength side.

Therefore, in the wavelength range including the spectrum sequence illustrated in FIG. 3, wavelength resolution and wavelength accuracy to be described later may be defined on the assumption that all the mode intervals Δλ are 4.42 nm. That is, when the error is acceptable, an average mode interval can be treated as the mode interval Δλ common to all the modes of the QCL element 2. It is noted that, in order to maintain such an oscillation state, it is preferable that the temperature of the QCL element 2 is stabilized by electronic cooling or the like. In addition, the QCL element 2 may be operated by pulse driving, but from a viewpoint of stabilizing the oscillation spectrum as illustrated in FIG. 3, it is preferable that no fluctuation occurs in the injection current, and thus, it is preferable that the QCL element 2 is operated by continuous driving.

The collimating lens 3 is disposed between the QCL element 2 and the diffraction grating 4. More specifically, the collimating lens 3 is disposed at a position facing the end surface (the emission surface of the laser light L) of the QCL element 2. The collimating lens 3 collimates the laser light L emitted from the QCL element 2. In the present embodiment, the collimating lens 3 suppresses spread of radiation light (the laser light L) from the QCL element 2, and collimates the laser light L so as to narrow down the light most on the slit surface. In other words, the collimating lens 3 collimates the laser light L such that a beam waist position of the laser light L matches the slit surface (the surface of the slit member 6 described later on a side opposite the light detector 8 side).

A material and a specification (a diameter, a focal length, and the like) of the collimating lens 3 can be selected according to a radiation angle (a spread angle) and a wavelength of the laser light L. The collimating lens 3 is, for example, an aspherical lens. The collimating lens 3 may be any lens capable of allowing mid-infrared light (the laser light L) to be transmitted therethrough, and may be formed of, for example, ZnSe. The diameter and the focal length of the collimating lens 3 are preferably set such that a beam diameter of the mode light M is narrowed down to a major axis of the slit or less at a position along the slit surface of the slit member 6 from a viewpoint of allowing the mode light M to be detected to suitably pass through a slit 6a of the slit member 6. In the present embodiment, as an example, the collimating lens 3 is a ZnSe aspherical lens having a diameter of 15 mm and a focal length of 3 mm. In addition, from a viewpoint of suppressing reflection of the laser light L on the surface of the collimating lens 3, a low reflection coating may be provided on both surfaces (that is, an incident surface and an emission surface of the laser light L) of the collimating lens 3 such that reflectance of the laser light L is 5% or less.

The diffraction grating 4 disperses the laser light L emitted from the QCL element 2 into a plurality of mode lights M. More specifically, the diffraction grating 4 disperses the laser light L into the plurality of mode lights M by reflecting the laser light L collimated by the collimating lens 3 at different angles for each wavelength component (mode). In FIG. 1, only three mode lights M1 to M3 are schematically illustrated. Specifically, FIG. 1 illustrates the mode light M2 corresponding to one mode that finally reaches the light detector 8 in the state (angle) of the diffraction grating 4 illustrated in FIG. 1 and the mode lights M1 and M3 corresponding to two modes adjacent to the one mode.

The diffraction grating 4 is preferably configured to decompose the adjacent mode lights M at a maximum wide angle. From the above viewpoint, it is preferable to use a diffraction grating having a small groove period (a large number of grooves per 1 mm) as the diffraction grating 4. However, in order to obtain diffracted light, the groove period of the diffraction grating 4 needs to be set to be larger than a half wavelength of the center wavelength of the QCL element 2. Therefore, in the present embodiment, as an example, the diffraction grating 4 is configured by a blazed diffraction grating having a groove period of 5 μm (that is, the number of grooves per 1 mm is 200). With such a diffraction grating 4, when the mode interval Δλ is 4.42 nm described above, the adjacent mode lights M can be decomposed at an angle of 0.05°. That is, an angle (a decomposition angle α to be described later) formed by the traveling directions of the respective adjacent mode lights M dispersed by the diffraction grating 4 becomes 0.05°.

The diffraction grating 4 has a drive mechanism configured to rotate the diffraction grating 4 in order to change an angle of the diffraction grating 4 (a diffraction grating surface on which the laser light L is incident). The drive mechanism can be configured by, for example, an electronically controlled motor, a piezo actuator, or the like. Angular resolution (rotation amount (angle) per unit operation) of the diffraction grating 4 is preferably set to an angle sufficiently smaller (for example, one or more digits) than a rotation amount (in the present embodiment,) 0.05° corresponding to the mode interval Δλ. The respective wavelength components (the respective mode lights M) angularly decomposed in the diffraction grating 4 are incident on a plane mirror 51 of the reflector 5 to be described later at respectively different angles.

The reflector 5 includes the plane mirror 51 (a first plane mirror) and a plane mirror 52 (a second plane mirror) that are disposed to face each other. The plane mirror 51 has a mirror surface 51a that faces the plane mirror 52 and reflects the mode light M. Similarly, the plane mirror 52 has a mirror surface 52a that faces the plane mirror 51 and reflects the mode light M. A sample S, which is a gas to be subjected to spectroscopic analysis, is disposed (introduced) between the plane mirrors 51 and 52.

As illustrated in FIG. 1, the plane mirror 51 and the plane mirror 52 are inclined to each other such that a distance between the plane mirror 51 and the plane mirror 52 increases from a side (an incident side S1) on which the mode light M is incident toward a side (an emission side S2) from which the mode light M is emitted to the light detector 8. The reflector 5 guides the mode light M (in the example of FIG. 1, the mode light M2) dispersed by the diffraction grating 4 to the light detector 8 while performing multiple reflection of the mode light M between the plane mirrors 51 and 52. As described above, the light detector 8 is configured to detect the mode light M transmitted through the sample S disposed between the plane mirrors 51 and 52.

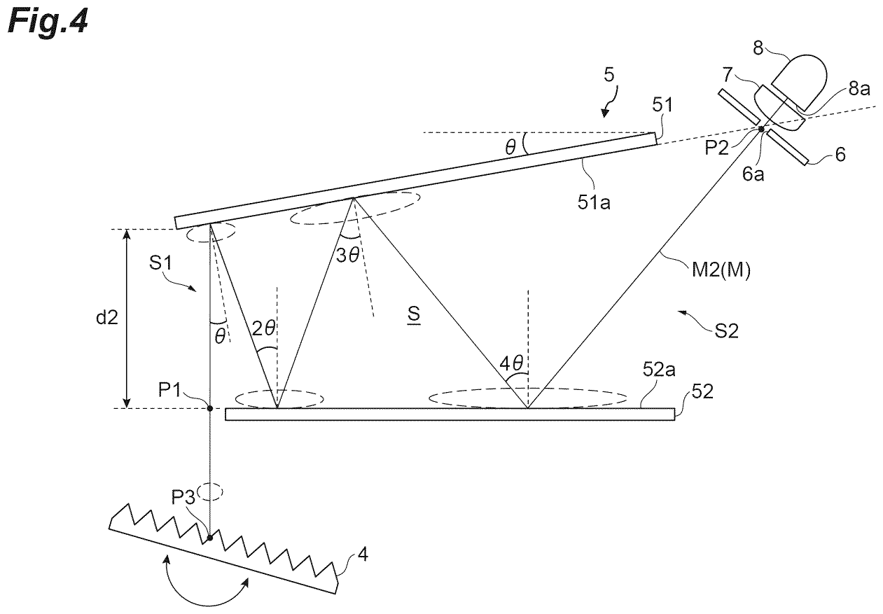

As illustrated in FIG. 4, in the present embodiment, the reflector 5, the slit member 6, the condensing lens 7, and the light detector 8 are disposed such that the mode light M2 that is dispersed (reflected) by the diffraction grating 4 and is incident on the plane mirror 51 in a direction orthogonal to the plane mirror 52 (the mirror surface 52a) finally passes through the slit 6a (an opening) of the slit member 6 and reaches the light detector 8. In order to facilitate such an arrangement design, the reflector 5 is arranged such that the mode light M dispersed by the diffraction grating 4 is first incident on the mirror surface 51a of the plane mirror 51. Further, an inclination angle 0 of the plane mirror 51 (the mirror surface 51a) relative to the plane mirror 52 (the mirror surface 52a) coincides with an incident angle obtained when the mode light M2 detected by the light detector 8 is first incident on the plane mirror 51.

In the example of FIG. 4, the mode light M2 incident on the plane mirror 51 at the same incident angle as the inclination angle θ is configured to be reflected four times in total between the plane mirrors 51 and 52 and then is directed to the light detector 8. Further, as illustrated in FIG. 1, different wavelength components (for example, the mode lights M1 to M3) are simultaneously incident on the plane mirror 51 at different angles, thereby respectively following different optical paths. As illustrated in FIG. 1, as the respective mode lights M1 to M3 that are angularly decomposed in the diffraction grating 4 and then are simultaneously incident on the plane mirror 51 travel along the respective optical paths while being repeatedly reflected between the plane mirrors 51 and 52, a distance of a reflection point for each wavelength component along the reflection surfaces (the mirror surface 51a and 52a) of the plane mirrors 51 and 52 (that is, a distance of a reflection point of each of the mode lights M1 to M3) gradually increases. As a result, each wavelength component is finally spatially separated in one direction, and the component (that is, the mode light M2 which is a component tracing the optical path illustrated in FIG. 4) that has passed through the slit 6a is dominantly selected and is detected by the light detector 8.

By continuously rotating the diffraction grating 4 in one direction, each of the mode lights M can pass through the slit 6a in order of wavelength (ascending or descending order of magnitude of wavelength). This enables the light detector 8 to detect each of the mode lights M independently in order of wavelength. Here, the magnitude (that is, a distance d1 illustrated in FIG. 1) of spatial separation between the adjacent modes on the slit surface is approximately calculated as “A×tan(α)” using an optical path length A from the reflection point in the diffraction grating 4 to the slit member 6 and the decomposition angle α between the adjacent modes (that is, an angle formed by the center axes of the adjacent mode lights M with each other). Therefore, in order to sufficiently separate the modes from each other, it is preferable to increase both the optical path length A and the decomposition angle α. In the present embodiment, as described above, the decomposition angle α is 0.05°. Additionally, a length from the incident side S1 to the emission side S2 of each of the plane mirrors 51 and 52 is 20 cm, an inclination angle θ is 1.5°, and a minimum distance (a distance d2 in FIG. 4) between the mirror surfaces 51a and 52a in a direction perpendicular to the mirror surface 52a is 5 cm. In this case, the mode light M2 is reflected 18 times in total between the plane mirrors 51 and 52, and the optical path length of the mode light M2 from a position P1 to a position P2 in FIG. 4 is about 91 cm. The position P1 is a position at which the mode light M2 reflected by the diffraction grating 4 first reaches the plane along the mirror surface 52a. The position P2 is a position at which the mode light M2 reaches an entrance (a position along the slit surface) of the slit 6a. Furthermore, when a distance from a reflection point P3 of the diffraction grating 4 to the position P1 is added, the optical path length A of the mode light M2 from a point at which the light is dispersed by the diffraction grating 4 to the entrance of the slit 6a (that is, the optical path length from the reflection point P3 to the position P2) is about 1 m. With this configuration, the distance d1 between the adjacent modes on the slit surface is about 870 μm (=1 m×tan(0.05°)).

The incident angle of the mode light M relative to the plane mirrors 51 and 52 increases by the inclination angle θ every time the mode light M is reflected between the plane mirrors 51 and 52 once. In the present embodiment, since the incident angle of the mode light M2 finally reaching the light detector 8 relative to the plane mirror 51 coincides with the inclination angle θ, the n-th incident angle of the mode light M2 relative to the plane mirrors 51 and 52 becomes “n×θ”. As a result, in each of the plane mirrors 51 and 52, it is possible to prevent band-shaped beams (broken-line frames in FIG. 4) expanding along with propagation of the mode light M2 from overlapping each other between adjacent reflection points. Specifically, as indicated by the broken-line frame in FIG. 4, the mode light M propagates while gradually expanding from the reflection point of the diffraction grating 4 toward the light detector 8. However, as described above, since the plane mirror 51 is disposed non-parallel to the plane mirror 52, a distance between the adjacent reflection points in each of the plane mirrors 51 and 52 can be increased each time the number of times of reflection increases, thereby making it possible to avoid interference between the band-shaped beams (the broken-line frames in FIG. 4) of the adjacent reflection points in the same plane mirror (the plane mirror 51 or 52). As a result, measurement accuracy of the mode light M of each mode can be improved.

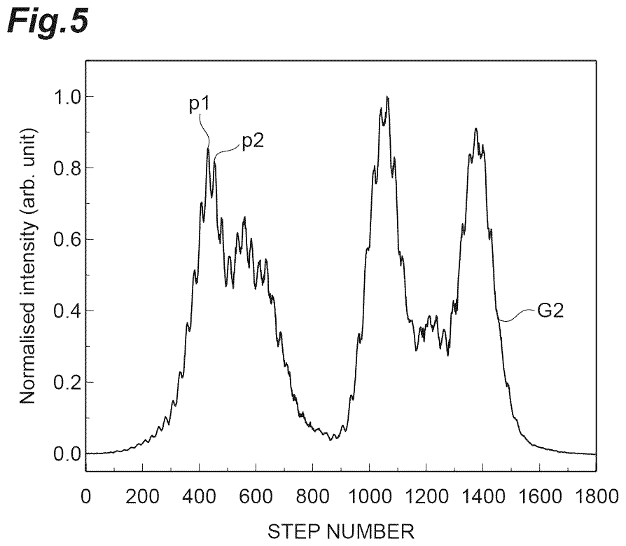

The slit member 6 is disposed between the sample S (in the present embodiment, the reflector 5 on which the sample S is disposed) and the light detector 8 on the optical path of the mode light M toward the light detector 8. The slit member 6 is provided with the slit 6a configured to selectively allow the mode light M (in the present embodiment, the mode light M2 incident on the plane mirror 51 in the direction perpendicular to the plane mirror 52) corresponding to one of the plurality of modes to pass therethrough. The slit 6a is an opening configured to separate and select one mode of the plurality of band-shaped mode lights M emitted from the reflector 5 and separated for each wavelength component, and to guide the selected mode light M to the light detector 8. The slit 6a is formed in, for example, a substantially rectangular shape. The longitudinal direction of the slit 6a coincides with a direction D1 (a direction parallel to the slit surface, which is a direction along the paper surface of FIG. 1) in which the adjacent mode lights M1 to M3 are shifted from each other and a direction orthogonal to the traveling direction of the mode light M2 (that is, a direction perpendicular to the paper surface in FIG. 1). The length of the slit 6a in the longitudinal direction is set to, for example, 1 mm or more and 5 mm or less, and the width (length in the direction D1) of the slit 6a is set to, for example, 10 μm or more and 200 μm or less. The width of the slit 6a can be set based on the distance d1 between the adjacent modes on the slit surface. In the present embodiment, as described above, since the distance d1 is about 870 μm, for example, by setting the width of the slit 6a to about 100 μm, a peak intensity of each of the modes adjacent to each other can be separately observed while securing a certain amount of light passing through the slit 6a. For example, when the mode light M2 passes through the slit 6a, it is possible to reduce a component passing through the slit 6a in the mode lights M1 and M3 adjacent to the mode light M2 while securing the light amount of the mode light M2 passing through the slit 6a. Accordingly, it is possible to more clearly observe a peak corresponding to the mode light M2 in a measurement result (a graph G2 in FIG. 5) to be described later.

The condensing lens 7 is disposed between the slit member 6 and the light detector 8. The condensing lens 7 condenses the light (in the example of FIG. 1, the mode light M2) having passed through the slit 6a on a light receiving surface 8a of the light detector 8. More specifically, the condensing lens 7 is disposed such that light having passed through the slit 6a forms an image on the light receiving surface 8a of the light detector 8. The condensing lens 7 can be formed of a material similar to that of the collimating lens 3. Further, similarly to the surface of the collimating lens 3, a low reflection coating may be provided on the surface of the condensing lens 7 (the incident surface and the emission surface of the mode light M).

The light detector 8 detects the mode light M that is dispersed by the diffraction grating 4 and then is transmitted through the sample S (in the present embodiment, the gas that is subjected to absorption spectroscopic analysis and is introduced between the plane mirrors 51 and 52). The light detector 8 may be any one as long as it has sensitivity to mid-infrared light (the mode light M). As the light detector 8, for example, a quantum type detector such as an InAsSb detector, an InSb detector, a quantum well infrared photodetector (QWIP), a quantum cascade detector (QCD), or an MCT detector can be used. According to the above configuration, the mode light M can be detected with higher sensitivity and higher speed as compared with a case in which a thermal detector is used as the light detector 8.

The analysis unit 9 analyzes the measurement result of the light detector 8 to acquire a signal value (light intensity) for each wavelength. The analysis unit 9 can be configured by, for example, one or more computer devices including a processor, a memory, an auxiliary storage device, and the like. In the present embodiment, the analysis unit 9 is configured to perform drive control of the QCL element 2, drive control of the diffraction grating 4, and acquisition of the detection result from the light detector 8. The operation of the analysis unit 9 will be described with reference to an actual measurement example illustrated in FIG. 5.

The graph G2 illustrated in FIG. 5 illustrates an example of a measurement result obtained by rotating the diffraction grating 4 at a rotation angle of 0.0025° per step by the above-described drive mechanism to cause the light detector 8 to detect each of the plurality of mode lights M dispersed by the diffraction grating 4 in ascending order of wavelengths. In FIG. 5, the horizontal axis represents the number of steps, and the vertical axis represents the signal value (intensity) of the detection signal of the light detector 8 in each step. More specifically, the vertical axis in FIG. 5 indicates the signal value of each step normalized such that the maximum value of the signal value becomes “1”. It can be seen that an envelope of the graph G2 illustrated in FIG. 5 is similar to an envelope of the graph G1 which is the measurement result of the FTIR illustrated in FIG. 3.

First, the analysis unit 9 operates the QCL element 2 with a preset injection current (730 mA in the present embodiment). In addition, the analysis unit 9 controls the operation (rotation operation) of the diffraction grating 4 such that each of the plurality of mode lights M is detected by the light detector 8 in order of wavelength magnitude (in the present embodiment, in ascending order of wavelengths). As a result, the analysis unit 9 acquires time-series data (that is, data corresponding to the graph G2 in FIG. 5) of the signal value detected by the light detector 8 (first processing).

In the graph G2 in FIG. 5, fine peaks (for example, peaks p1 and p2 in FIG. 5) corresponding to individual modes are observed. At a time point immediately after the graph G2 illustrated in FIG. 5 is obtained, since a wavelength corresponding to each peak is unknown, a signal value (light intensity) for each wavelength cannot be grasped from the graph G2. Here, if any peak (in the present embodiment, the number of steps) included in the graph G2 can be associated with a known wavelength, for example, wavelengths corresponding to all peaks (the number of steps) can be determined by using the above-described mode interval Δλ (in the present embodiment, 4.42 nm). For example, when the wavelength of the peak p1 of the graph G2 in FIG. 5 can be determined to be 9.01 μm, the wavelength corresponding to the peak p2 adjacent thereto can be calculated as “9.01 μm+Δλ”. In general, a wavelength corresponding to the n-th peak in the right direction (a direction in which the wavelength becomes long) from the peak p1 can be calculated as “9.01 μm+n×Δλ”. Similarly, a wavelength corresponding to the n-th peak in the left direction (a direction in which the wavelength becomes short) from the peak p1 can be calculated as “9.01 μm−n×Δλ”.

Therefore, the analysis unit 9 specifies a wavelength corresponding to at least one peak (a first peak) among the plurality of peaks included in the time-series data (in the present embodiment, the graph G2 in FIG. 5) acquired by the first processing (second processing). For example, the analysis unit 9 may specify a wavelength corresponding to any peak included in the graph G2 by comparing information (for example, the graph G1 in FIG. 3) indicating the oscillation spectrum of the laser light L acquired in advance with the time-series data (the graph G2). For example, the analysis unit 9 may specify which mode (wavelength) peak in the graph G1 corresponds to one peak included in the graph G2 by performing pattern matching on a graph pattern (a graph shape) between the graph G1 and the graph G2.

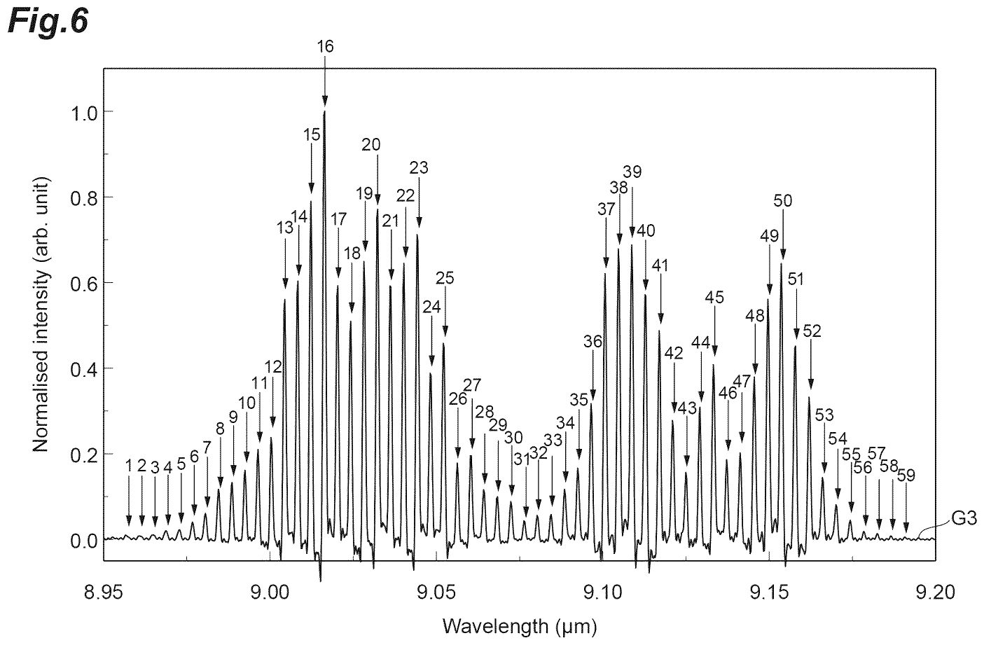

A graph G3 illustrated in FIG. 6 is a graph in which a number is associated with a peak corresponding to each mode included in the graph G1 in FIG. 3 in order from the short wavelength side. For example, a consideration will be given as to a case in which it can be determined that the peak p1 of the graph G2 in FIG. 5 corresponds to a sixteenth peak of the graph G3 by the pattern matching processing as described above. In this case, since the wavelength corresponding to the sixteenth peak of the graph G3 is known, the analysis unit 9 can determine the wavelength (for example, 9.01 μm) corresponding to the sixteenth peak of the graph G3 as the wavelength corresponding to the peak p1.

After the wavelength of one peak (here, the peak p1) is determined as described above, the analysis unit 9 determines the wavelength of a peak k (a second peak) other than the peak p1 among the plurality of peaks included in the graph G1 based on a positional relationship between the peak p1 and the peak k (third processing). That is, the analysis unit 9 determines the wavelength of the peak k based on the position (for example, at which n-th position the peak k is present from the peak p1 in the left direction or the right direction) of the peak k having the peak p1 as a reference.

As a first example of the third processing, the analysis unit 9 may determine the wavelength of the peak k by using the known mode interval Δλ as described above. For example, when the peak k is the n-th peak from the peak p1 in the right direction, the analysis unit 9 can determine the wavelength corresponding to the peak k as “9.01 μm+n×Δλ”.

As a second example of the third processing, the analysis unit 9 may specify wavelengths corresponding to all peaks of the graph G3 without using the mode interval Δλ. For example, the analysis unit 9 stores wavelengths corresponding to all peaks (modes) included in the graph G3 illustrated in FIG. 6 in association with the numbers allocated to the graph G3. For example, the analysis unit 9 acquires and stores information (N, λ_{N}) indicating a wavelength λ_{N} corresponding to the peak of the number N of the graph G3 for all the numbers N (in the example of FIG. 6, the number from 1 to 59). Such information can be acquired, for example, by accurately reading the wavelength of each peak from the measurement result of FTIR (the graph G3). In addition, the analysis unit 9 allocates the same number as the graph G3 to a plurality of peaks included in the graph G2 (FIG. 5) of the measurement result. That is, the analysis unit 9 associates the number (for example, “16” which is the same number) corresponding to the sixteenth peak of the graph G3 with the peak p1 of the graph G2. Then, the analysis unit 9 allocates a number “16+n” to a n-th peak k from the peak p1 to the right with the peak p1 as a reference and allocates a number “16-n” to the n-th peak k from the peak p1 to the left. As a result, the analysis unit 9 can allocate the wavelength of a m-th peak of the graph G3 to a m-th peak (m is any integer from 1 to 59) of the graph G2.

According to the first example of the third processing, the wavelengths corresponding to all the peaks of the measurement result (the graph G2) can be easily obtained at high speed by relatively simple calculation processing based on the known mode interval Δλ (the average mode interval). On the other hand, as described above, since the mode interval has wavelength dependency, each mode interval of the plurality of mode lights M does not strictly coincide with the above-described mode interval Δλ (the average mode interval). According to the second example of the third processing, since the wavelength of each mode measured in advance by FTIR or the like can be allocated to each peak of the measurement result (the graph G2) without using the mode interval Δλ, the wavelength of each peak of the graph G2 can be determined more accurately than the first example.

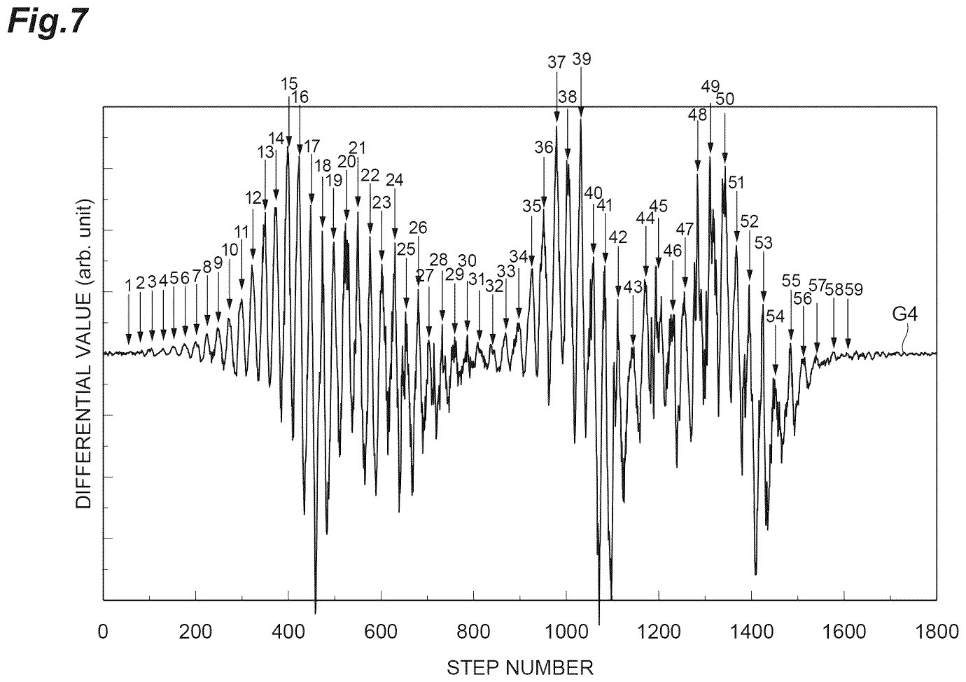

It is noted that, as in the graph G2 of FIG. 5, it may be difficult to specify a peak from raw data of an actual measurement result. This is because light of each mode spreads at a constant beam diameter on the slit surface of the slit member 6, and adjacent modes cannot be completely separated from each other. In such a case, as illustrated in FIG. 7, the analysis unit 9 may generate a graph G4 in which the peak position is actualized by differentiating the measurement result (the graph G2). The position of each peak in the graph G2 corresponds to a portion at which a differential value rapidly changes from a high value to a low value in the graph G4. By using such a graph G4, the peak position (the number of steps corresponding to the peak) in the graph G2 can be easily specified. For example, the analysis unit 9 sequentially allocates a number corresponding to each peak of the graph G3 to the portion changing as described above in the graph G4. Next, in the graph G2, the analysis unit 9 allocates the same number as the graph G4 to the same number of steps as the number of steps allocated with the numbers in the graph G4. As a result, it is possible to easily grasp the position (the number of steps) of each peak of the graph G2 and the number corresponding thereto (the peak of the corresponding graph G3) via the graph G4.

Furthermore, as another example of the second processing described above, the analysis unit 9 may execute the following processing. As a premise of the processing, the mode light M dispersed by the diffraction grating 4 is configured to pass through a specific substance that absorbs light of a specific wavelength before reaching the light detector 8. Such a specific substance can be arranged at any position that is a subsequent stage of the diffraction grating 4 and a preceding stage of the light detector 8. The state of the specific substance may be any of a gas, a liquid, and a solid. In this case, in the measurement result (time-series data) corresponding to the graph G2 in FIG. 5, an absorption line (a portion falling in a valley shape) is expected to be observed at a position (the number of steps) where the mode light M corresponding to a specific wavelength is guided to the light detector 8. Therefore, in this case, the analysis unit 9 may specify the position (that is, the number of steps corresponding to the position of the absorption line) of the absorption line appearing at the position corresponding to the specific wavelength in the time-series data (the graph G2 in FIG. 5), and may specify a wavelength corresponding to one peak based on the position of the absorption line. For example, by associating the specific wavelength with a peak that disappears by the absorption line in the time-series data, a wavelength obtained by adding (or subtracting) the mode interval Δλ to the specific wavelength can be associated with the peak (the first peak) adjacent to the absorption line.

### Operation and Effect of First Embodiment

The spectroscopic analyzer 1A described above includes the Fabry-Perot QCL element 2 that oscillates a plurality of discretely distributed mode lights M as a light source for spectroscopic analysis of a dispersion method. Thus, wavelength resolution and wavelength accuracy can be defined by the mode interval of the Fabry-Perot mode of the QCL element 2. In addition, since a light output of the Fabry-Perot QCL element 2 is larger than that of a lamp light source used as a light source in the conventional dispersion method, a light intensity of each discretized mode light M (each wavelength component) becomes relatively large, and thus, the light detector 8 is not required to have high sensitivity. Therefore, with the spectroscopic analyzer 1A, a configuration having high wavelength accuracy and wavelength resolution can be realized at low cost.

More specifically, according to the spectroscopic analysis using the spectroscopic analyzer 1A, even if an error occurs in an operation of the drive mechanism for rotating the diffraction grating 4 and, as such, an equal angular change is not guaranteed between adjacent steps, or even if reproducibility of a rotational operation of the diffraction grating 4 in the case of performing a plurality of times of measurement (spectroscopic analysis) is not secured (for example, a case in which the angle of the diffraction grating 4 at a m-th step at first measurement is different from the angle of the diffraction grating 4 at a m-th step at second measurement, or the like), wavelength resolution and wavelength accuracy can be secured by each peak of the detection signal (the graph G2 in FIG. 5) reflecting each wavelength component (mode) and the known mode interval Δλ. That is, the wavelength as described above is associated with each peak of the Fabry-Perot mode detected by the light detector 8, thereby making it possible to grasp a measurement value for each wavelength with certain accuracy. In addition, when wavelength resolution of the diffraction grating 4 is sufficiently higher than the mode interval Δλ, wavelength resolution as a spectroscope does not depend on the wavelength resolution of the diffraction grating 4 and always depends on the mode interval Δλ of the Fabry-Perot mode. Therefore, the required specifications for the drive mechanism of the diffraction grating 4 for enhancing the wavelength accuracy and the wavelength resolution can be greatly alleviated.

In the spectroscopic analyzer 1A, it may be difficult to measure an absorption line narrower than the mode interval Δλ, but in such a case as well, it is possible to detect the absorption line by appropriately setting the drive temperature, the injection current, and the like of the QCL element 2 and slightly moving (shifting) each mode of the QCL element 2 on the wavelength axis. In addition, since a width of a peak corresponding to each mode is sufficiently narrower than, for example, the absorption lines of various gases under atmospheric pressure, the spectroscopic analyzer 1A can perform highly sensitive absorption spectroscopic analysis with each mode light corresponding to a plurality of discrete peaks.

In addition, as illustrated in FIGS. 2 and 3, in the laser light L emitted from the QCL element 2, an average output of 60 mW is allocated to about 60 discretized wavelength components (each mode) under the condition of an injection current of 730 mA, so that a light amount of about 1 mW on average per mode is expected. Compared with a general lamp light source, the reason why a light intensity of about 1 mW can be maintained even when each spectral component is decomposed is that the laser light source has a higher intensity than that of the lamp light source, and in addition, energy is concentrated on a mode in which an emission spectral width is narrower than that in the lamp light source and is discretized. As described above, by using the QCL element 2 capable of sufficiently maintaining the light intensity of each mode as a light source, sensitivity requirement for the light detector 8 can be significantly alleviated.

In addition, the spectroscopic analyzer 1A includes the reflector 5. The plane mirrors 51 and 52 are inclined to each other such that a distance between the plane mirrors 51 and 52 increases from the incident side S1 of the mode light M toward the emission side S2 of the mode light M. The light detector 8 detects the mode light M transmitted through the sample S disposed between the plane mirrors 51 and 52. According to the above configuration, by performing multiple reflection of the mode light M between the plane mirrors 51 and 52 having the sample S disposed therebetween, it is possible to lengthen the optical path length of the mode light M passing through a space between the plane mirrors 51 and 52 while suppressing an increase in size of the spectroscopic analyzer 1A. Accordingly, it is possible to secure a length (an absorption length) of a region in which the mode light M having a specific wavelength is absorbed by the sample S in absorption spectrometry. In addition, since the interval (the distance d1 in FIG. 1) between the adjacent modes can be increased by increasing the optical path length, it is easy to individually detect each mode light M by the light detector 8. That is, in the measurement result (the graph G2) illustrated in FIG. 5, the peak corresponding to each mode can be more conspicuous.

In addition, the inclination angle 0 of the plane mirror 51 relative to the plane mirror 52 is configured to coincide with an incident angle obtained when the mode light M (in the example of FIG. 1, the mode light M2) detected by the light detector 8 is first incident on the plane mirror 51. According to the above configuration, it is possible to facilitate an arrangement design of the optical path of the mode light M2 that travels by performing multiple reflection between the plane mirrors 51 and 52 and the light detector 8 corresponding thereto. More specifically, the mode light M2 incident on the plane mirror 51 in a direction perpendicular to the plane mirror 52 can be guided to the light detector 8. In addition, since the n-th incident angle of the mode light M2 relative to the plane mirrors 51 and 52 can be easily calculated by calculation of “n×θ”, the optical path of the mode light M2 can be easily grasped, and the slit member 6, the condensing lens 7, and the light detector 8 can be easily appropriately disposed according to the optical path.

The spectroscopic analyzer 1A also includes the slit member 6 disposed between the sample S (in the present embodiment, the reflector 5) and the light detector 8 on the optical path of the mode light M2. The slit member 6 is provided at the front stage of the light detector 8, thereby making it possible to cause the light detector 8 to selectively detect only light of one mode (wavelength component).

It is noted that, in the measurement result (the graph G2) illustrated in FIG. 5, a peak derived from each mode is observed, but each mode is not completely separated as in the spectrum (the graph G1) shown in FIG. 3. This is because the beams (in the example of FIG. 1, beams of the mode lights M1, M2, and M3) of the respective modes spread with a constant beam diameter on the slit surface and overlap each other. Therefore, by reducing such overlap as much as possible, the modes can be more clearly separated from each other, and the peak derived from each mode in the graph G2 can be more conspicuous. To this end, it is preferable to perform alignment such that the laser light L (light including the plurality of mode lights M) having passed through the collimating lens 3 is condensed on the slit surface. In other words, the position of a beam waist of the laser light L collimated by the collimating lens 3 is preferably aligned with the position of the slit 6a. According to the above configuration, adjacent mode lights can be more clearly separated at the slit position, and each mode light M can be independently detected. That is, when the mode light M2 passes through the slit 6a, it is possible to reduce a component passing through the slit 6a among the lights (for example, the mode lights M1 and M3) other than the mode light M2. Furthermore, by suppressing the spread of the beam on the slit surface, an effect of increasing a light amount of the mode light M2 itself passing through the slit 6a is also exhibited. As described above, in the measurement result (the graph G2), the peak corresponding to the mode light M2 can be more conspicuous.

It is noted that it is also conceivable to omit the slit member 6 by reducing the light receiving surface 8a of the light detector 8. When the slit member 6 is omitted in this manner, the position of the beam waist of the laser light L collimated by the collimating lens 3 may be adjusted to match the position of the light receiving surface 8a of the light detector 8. According to the above configuration, the adjacent mode lights M can be more clearly separated from each other on the light receiving surface 8a of the light detector 8, and the light of each mode can be easily detected independently.

In addition, the spectroscopic analyzer 1A includes the analysis unit 9, and the analysis unit 9 is configured to execute the first processing, the second processing, and the third processing described above. According to the above configuration, by extracting the peaks (for example, the peaks p1 and p2 of the graph G2 in FIG. 5, and the like) derived from respective modes included in the measurement result (the time-series data) and determining wavelengths corresponding to the respective peaks, it is possible to appropriately grasp a signal value for each wavelength while securing wavelength resolution and wavelength accuracy as a spectroscope by a mode interval (a peak interval). In the second processing, the analysis unit 9 may determine a wavelength corresponding to at least one peak (the first peak) included in the time-series data by comparing information (in the present embodiment, the graph G1 in FIG. 3) indicating the oscillation spectrum of the laser light L acquired in advance with the time-series data (in the present embodiment, the graph G2 in FIG. 5). According to the above configuration, it is possible to appropriately determine the wavelength corresponding to the first peak serving as a reference when the third processing is executed based on the oscillation spectrum of the laser light L acquired in advance.

Alternatively, the mode light M dispersed by the diffraction grating 4 may be configured to pass through a specific substance that absorbs light of a specific wavelength before reaching the light detector 8. Further, the analysis unit 9 may specify the position of an absorption line appearing at the position corresponding to the specific wavelength in the time-series data (the graph G2) in the second processing, and may determine, based on the position of the absorption line, the wavelength corresponding to at least one peak included in the time-series data. According to the above configuration, the wavelength corresponding to the first peak serving as the reference when the third processing is executed can be appropriately determined based on the position of the absorption line observed in the measurement result (the time-series data).

In the above embodiment, as the diffraction grating 4, a MEMS diffraction grating (that is, a MEMS diffraction grating in which the diffraction grating and a rotation mechanism are integrated with each other) configured to be rotatable so as to change an incident angle of laser light with respect to the diffraction grating may be used. In a case where the MEMS diffraction grating is used as the diffraction grating 4, it is possible to miniaturize the spectroscopic analyzer 1A and to perform high-speed angular sweep (that is, wavelength (mode) scanning of the mode light M detected by the light detector 8). It is noted that, when the MEMS diffraction grating is used as the diffraction grating 4, the horizontal axis of the measurement result (the graph G2) illustrated in FIG. 5 of the above embodiment is replaced with “time” from “number of steps”.

It is noted that, since the angle change by the MEMS diffraction grating is high speed and continuous, it is necessary that time resolution of the light detector 8 is sufficiently higher than the angle sweep speed of the MEMS diffraction grating. For example, in a case where the MEMS diffraction grating operates at 1.8 kHz, when one reciprocating drive of the MEMS diffraction grating is regarded as two sweeps, the time required for one angular sweep is 0.28 ms (=(1s/1800)/2). As illustrated in FIG. 3, when a width of an oscillation spectrum (a range including the spectrum of the graph G1) is set to 200 nm (8.975 μm to 9.175 μm) and this wavelength width is swept in 0.28 ms, the time required for the wavelength sweep per 1 nm is 1.4 μs. As described above, in the present embodiment, since the mode interval Δλ is 4.42 nm, the time required for sweeping between the adjacent modes is 6.2 μs (=1.4 μs×4.42). Therefore, at least when time resolution of the light detector 8 is sufficiently smaller than the time required for sweeping between the modes (for example, about 1 μs), it is possible to perform measurement between adjacent modes at six data points. Here, since the above-described quantum type detector (InAsSb, InSb, InAs, MCT, QWIP, QCD, or the like) generally has time resolution (that is, a time shorter than 100 ns) higher than 100 ns, there is no problem. On the other hand, when a thermal detector having a long response time is used as the light detector 8, it is not suitable to use the MEMS diffraction grating. That is, when the MEMS diffraction grating is used as the diffraction grating 4, it is added as a design requirement that the time resolution of the light detector 8 has a time resolution sufficiently smaller than the time required for sweeping between the modes. However, when the design requirement can be satisfied by using a detector having a relatively high time resolution such as a quantum type detector as the light detector 8, the above-described merit can be obtained by using the MEMS diffraction grating.

### Second Embodiment

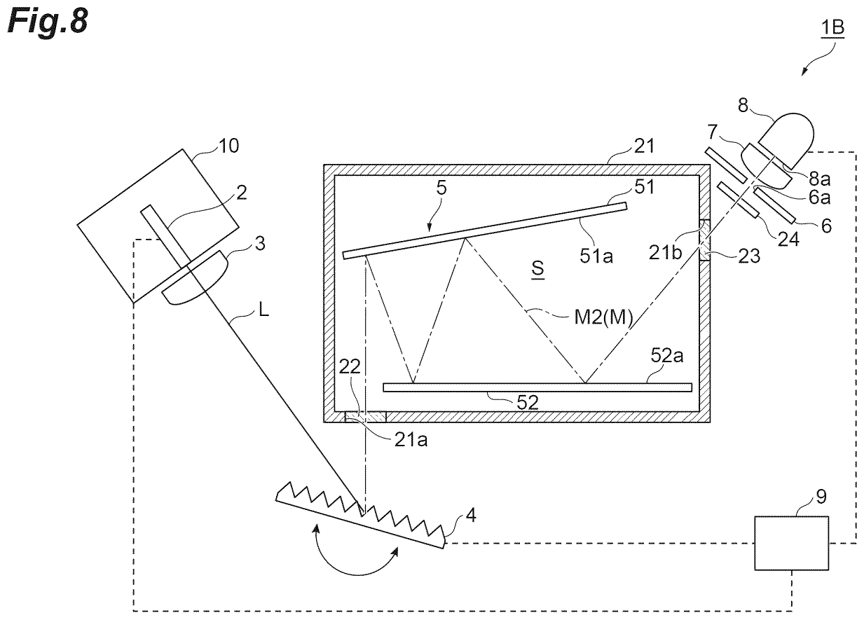

A spectroscopic analyzer 1B according to a second embodiment will be described with reference to FIG. 8. As illustrated in FIG. 8, the spectroscopic analyzer 1B is different from the spectroscopic analyzer 1A of the first embodiment in that the spectroscopic analyzer 1B further includes a housing 21 that houses the reflector 5 together with the gas sample (the sample S), and a cylindrical lens 24.

The reflector 5 realizes mode decomposition (that is, the length of the distance d1 in FIG. 1 is increased) on the slit surface by propagation of light in a long optical path (the mode light M), and also has a function as a multiple reflection gas cell in which the optical path length is compactly folded. When measurement is performed in an open path in which pressure of the gas to be measured (the sample S) is not controlled, the reflector 5 may be exposed to the atmosphere as in the first embodiment, but the present embodiment is suitable when it is necessary to control the pressure of the gas to be measured. That is, with the spectroscopic analyzer 1B, the gas to be measured is enclosed in the housing 21, and the pressure in the housing 21 can be controlled. It is noted that, as the housing 21, metal, glass, a resin material, or the like having strength that does not deform with respect to pressure changes such as vacuum and high pressure can be used. As an example, the housing 21 is provided with an opening 21a configured to allow the mode light M dispersed by the diffraction grating 4 to be incident on the housing 21, and an opening 21b configured to emit the mode light M from the inside of the housing 21 toward the light detector 8. The respective openings 21a and 21b are airtightly provided with window members 22 and 23 that allow the mode light M to be transmitted therethrough. The window members 22 and 23 may be formed of, for example, the same material (ZnSe) as each lens (the collimating lens 3, the condensing lens 7, and the like), and a low reflection coating may be provided on the surfaces thereof. In addition, the housing 21 may be provided with an intake port and an exhaust port (not illustrated) for replacing gas.

The cylindrical lens 24 is disposed between the sample S (in the present embodiment, the housing 21 in which the sample S is enclosed) and the slit member 6 on the optical path of the mode light M. That is, the cylindrical lens 24 is disposed in front of the slit member 6. The cylindrical lens 24 is configured to condense the mode light M in the longitudinal direction of the slit 6a (a direction perpendicular to the paper surface in FIG. 8). According to the above configuration, by compressing the mode light M incident on the slit 6a in the longitudinal direction of the slit 6a, the light amount of the mode light M passing through the slit 6a can be increased, and the light amount of the mode light M finally incident on the light detector 8 can be increased. As a result, a signal-to-noise ratio (S/N) of a detection signal in the light detector 8 can be improved.

The cylindrical lens 24 may be disposed in the first embodiment, or may be disposed in a third embodiment and a fourth embodiment to be described later. When the cylindrical lens 24 is disposed in these embodiments, a similar effect is also obtained. It is noted that, even when the slit member 6 is omitted, the cylindrical lens 24 may be disposed between the sample S and the light detector 8 on the optical path of the mode light M. In this case, the cylindrical lens 24 condenses the mode light M in a direction (that is, a direction perpendicular to the paper surface in FIGS. 1 and 8, and the like) orthogonal to both the direction (the direction D1 in FIG. 1) in which the adjacent mode lights M are shifted from each other and the traveling direction of the mode light M. As a result, it is possible to increase the amount of light incident on the light detector 8 by condensing the mode light M in one direction while maintaining a state in which the adjacent mode lights M are separated from each other by the cylindrical lens 24.

### Third Embodiment

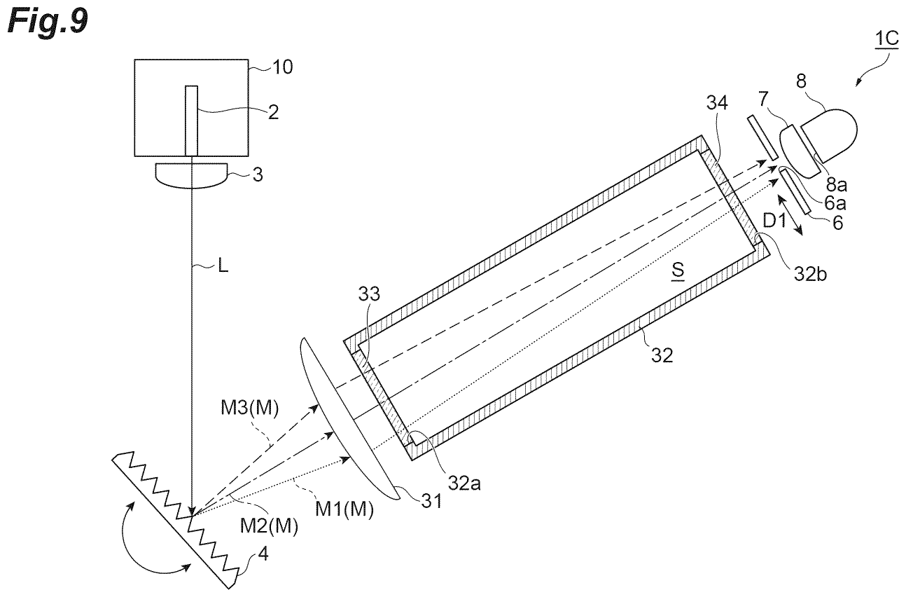

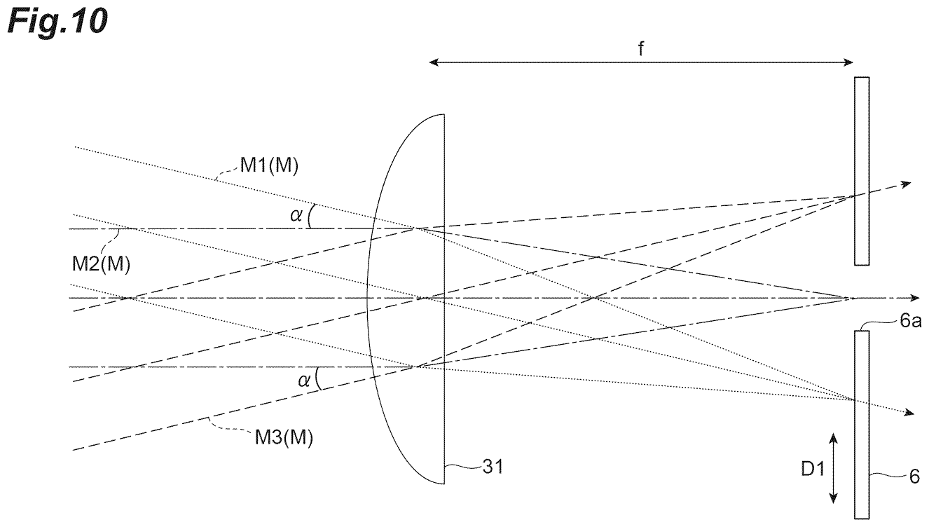

A spectroscopic analyzer 1C according to the third embodiment will be described with reference to FIGS. 9 and 10. As illustrated in FIG. 9, the spectroscopic analyzer 1C is different from the spectroscopic analyzer 1A of the first embodiment in that the spectroscopic analyzer 1C does not include the reflector 5 but further includes a long focus lens 31 and a housing 32 that houses the gas sample (the sample S).

The long focus lens 31 is a lens disposed between the diffraction grating 4 and the light detector 8 (in the present embodiment, between the diffraction grating 4 and the sample S (the housing 32)) and configured to allow a plurality of mode lights M dispersed by the diffraction grating 4 to pass therethrough. The focal length of the long focus lens 31 is 15 cm or more and 3 m or less. In the spectroscopic analyzer 1C, the respective mode lights M (in FIG. 9, only three mode lights M1, M2, and M3 are illustrated) angularly decomposed for respective wavelength components by the diffraction grating 4 are incident on the long focus lens 31 at different angles. The respective lights incident on the long focus lens 31 are condensed at different positions on the focal plane of the long focus lens 31 according to the incident angle relative to the long focus lens 31. Therefore, for example, by arranging the slit member 6 on the focal plane of the long focus lens 31, the respective mode lights M positionally decomposed by the long focus lens 31 can individually pass through the slit 6a and can be detected by the light detector 8. The condensing points of the respective mode lights M on the focal plane of the long focus lens 31 are arranged in one line while having a constant diameter in the direction D1 perpendicular to the longitudinal direction of the slit 6a and partially overlapping each other. Therefore, in order to more largely separate the condensing points of the respective mode lights M (that is, a distance between the condensing points of the adjacent mode lights M is further increased), the angular resolution of the diffraction grating 4 may be increased (the groove period of the diffraction grating 4 is reduced or the mode interval Δλ is widened), or the long focus lens 31 having a longer focal length may be used.

Similarly to the housing 21, the housing 32 encloses the sample S, which is a gas to be measured, therein. The housing 32 is formed in a rectangular parallelepiped shape extending in a direction in which the long focus lens 31 and the slit member 6 face each other between the long focus lens 31 and the slit member 6. As the material of the housing 32, the same material as that of the housing 21 can be used. In addition, the housing 32 is provided with an opening 32a configured to allow the mode light M having passed through the long focus lens 31 to be incident on the housing 32, and an opening 32b configured to emit the mode light M from the inside of the housing 32 toward the light detector 8. The respective openings 32a and 32b are airtightly provided with window members 33 and 34 that allow the mode light M to be transmitted therethrough. The window members 33 and 34 can be configured similarly to the window members 22 and 23 of the second embodiment. In addition, similarly to the housing 21, the housing 32 may be provided with an intake port and an exhaust port (not illustrated) for replacing gas.

FIG. 10 is a diagram schematically illustrating a relationship between the respective mode lights M (M1, M2, and M3) passing through the long focus lens 31 and respective condensing points of the focal plane (the slit surface). As illustrated in FIG. 10, the respective mode lights M incident on the long focus lens 31 travel straight in a direction passing through the center of the long focus lens 31 and are focused at a position (focal plane) advanced by a focal length f. Therefore, an interval between the adjacent condensing points is calculated as “f×tan(α)” using the focal length f and a decomposition angle α between the adjacent modes. For example, when the decomposition angle α is set to 0.05° using the long focus lens 31 having a focal length of 30 cm, an interval (a mode interval) between the adjacent condensing points is calculated to be about 260 μm.

The mode interval (260 μm) is smaller than the mode interval (870 μm) on the slit surface in the first embodiment, but since each mode light M can be focused small on the focal plane (that is, the slit surface) of the long focus lens 31, the adjacent mode lights M can be sufficiently spatially separated from each other. In the present embodiment, the width of the slit 6a may be set to, for example, about 10 μm according to the mode interval (260 μm). Although the slit width (10 μm) is narrower than the slit width (100 μm) of the first embodiment, as described above, in the present embodiment, since the mode light M is focused by the long focus lens 31, power density of the mode light M at the slit position is higher than that in the first embodiment in which the long focus lens 31 is not used. Therefore, the mode light M can be detected without any problem in the light detector 8.

However, in a case where the focal length f exceeds 3 m, the condensing point on the focal plane does not become sufficiently small, and power density of the mode light M at the slit position does not become sufficiently high. Therefore, efficient light detection in the light detector 8 becomes difficult. Therefore, the focal length f is preferably at least 3 m or less. In addition, in a case where the focal length f is less than 15 cm, it is easy to reduce the condensing point to about the slit width, but a distance between the long focus lens 31 and the slit member 6 is shortened. Therefore, the optical path length (that is, a section in which the mode light M and the sample S interact with each other) of the mode light M in the housing 32 is also shortened. As a result, highly sensitive absorption spectroscopy becomes difficult. From the above viewpoint, in the spectroscopic analyzer 1C, the focal length of the long focus lens 31 is set to 15 cm or more and 3 m or less. According to the above configuration, while avoiding the above-described disadvantage, the respective plurality of mode lights M incident on the long focus lens 31 can be focused at different positions on the focal plane of the long focus lens 31 according to the incident angle relative to the long focus lens 31. This makes it easy for the light detector 8 to individually detect the plurality of mode lights M.

It is noted that, in the present embodiment, a configuration to increase the optical path length of the mode light M by multiple reflection of the mode light M may be adopted between the long focus lens 31 and the slit member 6 as in the reflector 5 of the first embodiment and the second embodiment. For example, a reflection mechanism for forming an optical path for guiding the mode light M to the light detector 8 side while performing multiple reflection of the mode light M may be disposed inside the housing 32. Examples of such a reflection mechanism include a pair of plane mirrors disposed in parallel and configured to face each other, or a so-called multi-pass cell such as a Herriott cell.

In addition, in a case where the size of the light receiving surface 8a of the light detector 8 is sufficiently small, the slit member 6 and the condensing lens 7 may be omitted, and the light detector 8 may be disposed such that the focal plane of the long focus lens 31 and the light receiving surface 8a coincide with each other. Alternatively, the slit member 6 and the condensing lens 7 may be omitted, and the cylindrical lens 24 described in the second embodiment may be disposed between the long focus lens 31 and the light detector 8. In this case, the mode light M to be detected can be made incident on the light detector 8 more efficiently. More specifically, the cylindrical lens 24 may be disposed such that the focal plane of the cylindrical lens 24 and the focal plane of the long focus lens 31 coincide with each other, and the cylindrical lens 24 may collect the mode light M in a direction (a direction perpendicular to the paper surface in FIG. 9) perpendicular to the direction (the direction D1) in which the respective mode lights M are separated from each other by the diffraction grating 4.

### Fourth Embodiment

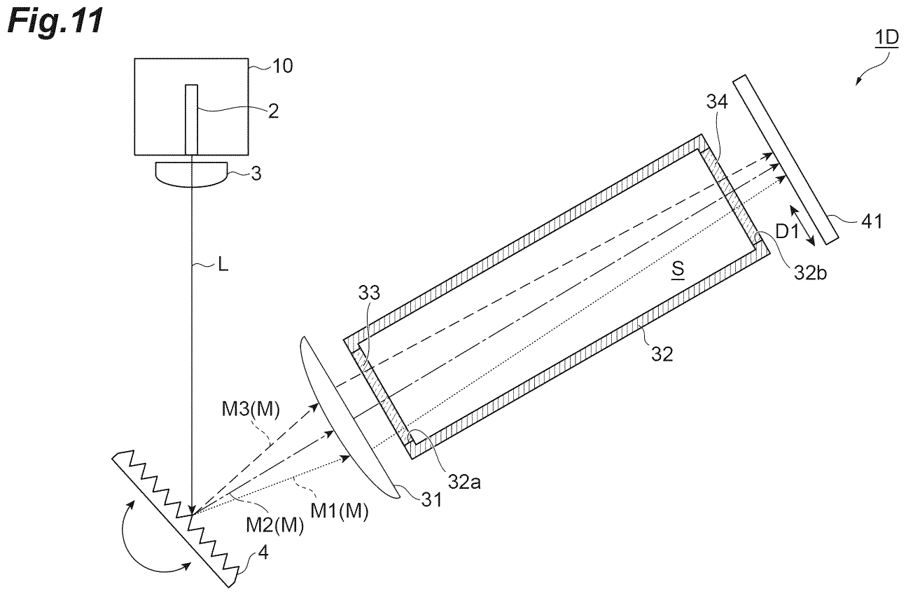

A spectroscopic analyzer 1D according to a fourth embodiment will be described with reference to FIG. 11. As illustrated in FIG. 11, the spectroscopic analyzer 1D is different from the spectroscopic analyzer 1C of the third embodiment in that a light detector 41 is provided instead of the slit member 6, the condensing lens 7, and the light detector 8.

As described in the third embodiment, in a case where the long focus lens 31 is used, the plurality of mode lights M are condensed at different positions on the focal plane of the long focus lens 31 according to the incident angle relative to the long focus lens 31 (refer to FIG. 10). That is, the condensing points of the mode lights M are disposed at substantially equal intervals in the direction (the direction D1) in which the mode lights M are separated from each other by the diffraction grating 4 on the focal plane of the long focus lens 31. The light detector 41 is a line sensor including a plurality of light receiving elements disposed at positions corresponding to the condensing points of the respective mode lights M in the direction D1. The number of light receiving elements of the line sensor (the light detector 41) is preferably equal to or greater than the number of modes to be measured (in the present embodiment, about 60). When the line sensor is used in this manner, the angle of the diffraction grating 4 may be fixed.

### Modifications

Although some embodiments and some modifications of the present disclosure have been described above, the present disclosure is not limited to the configurations described in the above embodiments and modifications. The material and shape of each configuration are not limited to the specific material and shape, and various materials and shapes other than those describe above can be adopted. In addition, some configurations included in the above-described embodiments and modifications may be appropriately omitted or changed, or may be freely and selective combined with each other. For example, in the spectroscopic analyzer 1D of the fourth embodiment (FIG. 11) as well, the cylindrical lens 24 of the second embodiment may be disposed at a preceding stage of the light detector 41 (between the light detector 41 and the housing 32). In addition, in the spectroscopic analyzers 1C and 1D, when it is not necessary to control pressure of the sample S, the housing 32 enclosing the sample S therein may be omitted as in the spectroscopic analyzer 1A of the first embodiment.

Furthermore, in the present specification, the diffraction grating 4 (including the MEMS diffraction grating) has been described as an example of the spectroscopic unit that disperses the laser light L into the plurality of mode lights M, but the spectroscopic unit is not limited to the diffraction grating. For example, a spectroscopic element other than a diffraction grating, such as a prism, may be used as the spectroscopic unit.

Furthermore, in the present specification, as an example of the spectroscopic analysis method to which the spectroscopic analyzer is applied, absorption spectroscopy adopted to analyze components or characteristics of the sample S by analyzing the absorption light (wavelength) of the predetermined gas sample (the sample S) has been described. However, the spectroscopic analyzer may be applied to a spectroscopic analysis method other than the above-described spectroscopic analysis method. In addition, the sample S is not limited to a gas, and may be, for example, a solid substance. When the solid sample S is a target to be analyzed, the light detector 8 may be configured to detect the mode light M reflected by the surface of the sample S. In this case, for example, the mode light M that is incident on a specific position on the surface of the sample S from a specific direction and is reflected may be configured to be incident on the light receiving surface 8a of the light detector 8. In this case, for example, by changing the angle of the diffraction grating 4 and changing the wavelength component (mode) incident from a specific direction to a specific position on the surface of the sample S, it is possible to obtain a measurement result (a graph corresponding to the graph G2 in FIG. 5) of each of the plurality of mode lights M, similarly to the spectroscopic analyzer 1A.

In addition, in the present specification, the Fabry-Perot QCL element (FP-QCL) is used as a light source (that is, as in the graph G1 illustrated in FIG. 3, a light source having spectral characteristics having a plurality of discrete peaks) having a discrete oscillation spectrum, but another light source having similar spectral characteristics may be used as a light source of the spectroscopic analyzer.

What is claimed is:

1. A spectroscopic analyzer comprising:
a Fabry-Perot quantum cascade laser element configured to emit a laser light including a plurality of mode lights respectively corresponding to a plurality of modes indicating a discrete oscillation spectrum;
a spectroscopic unit configured to disperse the laser light emitted from the quantum cascade laser element into the plurality of mode lights; and
a light detector configured to detect the mode light dispersed by the spectroscopic unit and then transmitted through a sample or reflected by the sample.

2. The spectroscopic analyzer according to claim 1, further comprising a reflector including a first plane mirror and a second plane mirror disposed to face each other, the reflector guiding the mode light to the light detector while performing multiple reflection of the mode light between the first plane mirror and the second plane mirror, wherein
the first plane mirror and the second plane mirror are inclined to each other such that a distance between the first plane mirror and the second plane mirror increases from a side on which the mode light is incident toward a side from which the mode light is emitted to the light detector, and
the light detector is configured to detect the mode light transmitted through the sample disposed between the first plane mirror and the second plane mirror.

3. The spectroscopic analyzer according to claim 2, wherein
the reflector is disposed to allow the mode light to be first incident on the first plane mirror, and
the first plane mirror has an inclination angle relative to the second plane mirror, the inclination angle being configured to coincide with an incident angle obtained when the mode light detected by the light detector is first incident on the first plane mirror.

4. The spectroscopic analyzer according to claim 1, wherein the spectroscopic unit is a MEMS diffraction grating configured to be rotatable so as to change an incident angle of the laser light relative to the spectroscopic unit.

5. The spectroscopic analyzer according to claim 1, further comprising a slit member disposed between the sample and the light detector on an optical path of the mode light, the slit member having a slit provided therein and configured to selectively allow the mode light corresponding to one of the plurality of modes to pass therethrough.

6. The spectroscopic analyzer according to claim 5, further comprising a collimating lens disposed between the quantum cascade laser element and the spectroscopic unit and configured to collimate the laser light,
wherein a position of a beam waist of the laser light collimated by the collimating lens is aligned with a position of the slit.

7. The spectroscopic analyzer according to claim 5, further comprising a cylindrical lens disposed between the sample and the slit member on the optical path of the mode light and configured to condense the mode light in a longitudinal direction of the slit.

8. The spectroscopic analyzer according to claim 1, further comprising a collimating lens disposed between the quantum cascade laser element and the spectroscopic unit and configured to collimate the laser light,
wherein a position of a beam waist of the laser light collimated by the collimating lens is aligned with a position of a light receiving surface of the light detector.

9. The spectroscopic analyzer according to claim 1, wherein the light detector is a quantum type detector.

10. The spectroscopic analyzer according to claim 1, further comprising a cylindrical lens disposed between the sample and the light detector on an optical path of the mode light and configured to condense the mode light in a direction orthogonal to both a direction in which the mode lights adjacent to each other are shifted from each other and a traveling direction of the mode light.

11. The spectroscopic analyzer according to claim 1, further comprising a long focus lens disposed between the spectroscopic unit and the light detector, wherein the long focus lens allows the plurality of mode lights dispersed by the spectroscopic unit to pass therethrough and has a focal length of 15 cm or more and 3 m or less.

12. The spectroscopic analyzer according to claim 1, wherein the quantum cascade laser element is configured to generate light by a transition between a plurality of subbands.

13. The spectroscopic analyzer according to claim 1, wherein the quantum cascade laser element is configured to include a plurality of active layers having center wavelengths different from each other.

14. The spectroscopic analyzer according to claim 1, further comprising an analysis unit configured to analyze a measurement result of the light detector,
wherein the analysis unit is configured to execute:
first processing of acquiring time-series data of a signal value detected by the light detector by controlling an operation of the spectroscopic unit so that each of the plurality of mode lights is detected by the light detector in order of wavelength magnitude;
second processing of determining a wavelength corresponding to at least one first peak among a plurality of peaks included in the time-series data acquired by the first processing; and
third processing of determining a wavelength of a second peak other than the first peak among the plurality of peaks based on a positional relationship between the first peak and the second peak.

15. The spectroscopic analyzer according to claim 14, wherein the analysis unit is configured to determine, in the second processing, the wavelength corresponding to the first peak by comparing information indicating an oscillation spectrum of the laser light acquired in advance with the time-series data.

16. The spectroscopic analyzer according to claim 14, wherein
the mode light dispersed by the spectroscopic unit is configured to, before reaching the light detector, pass through a specific substance that absorbs light of a specific wavelength, and
the analysis unit is configured to, in the second processing, specify a position of an absorption line appearing at a position corresponding to the specific wavelength in the time-series data and determine the wavelength corresponding to the first peak based on the position of the absorption line.
